(19) United States
(12) Patent Application Publication
(10) Pub. No.: US 2011/0100255 A1
(43) Pub. Date: May 5, 2011

(54) CORE MATERIAL MIXTURE, METHOD OF FABRICATING CORE FOR CASTING AND CORE FABRICATED BY THE SAME

(75) Inventors: Han Jae Kim, Gunpo (KR); Soo-Hyun Huh, Incheon (KR)

(73) Assignees: HYUNDAI MOTOR COMPANY, Seoul (KR); KIA MOTORS CORPORATION, Seoul (KR); YOUNG IL CHEMICAL CO., LTD., Incheon (KR)

(21) Appl. No.: 12/754,193

(22) Filed: Apr. 5, 2010

(30) Foreign Application Priority Data
Oct. 30, 2009 (KR) 10-2009-0103914

(51) Int. Cl. C09D 1/02

(52) U.S. Cl. 106/38.35; 106/38.3

(57) ABSTRACT

The present invention features a core material mixture for casting that prevents strength from being decreased and improves de-coring properties. The core material mixture preferably includes molding sand, and a core binder consisting of sodium silicate-based binder and an oxide film inhibitor. The present invention also provides a method of fabricating a core for a casting and a core for the casting fabricated by the same method.

### CROSS-REFERENCE TO RELATED APPLICATION

This application claims under 35 U.S.C. §119(a) the benefit of Korean Patent Application No. 10-2009-0103914, filed on Oct. 30, 2009 in the Korean Intellectual Property Office, the disclosure of which is incorporated herein in its entirety by reference.

### BACKGROUND

1. Field of the invention

The present invention relates, generally, to a core material mixture for a casting, and more particularly, to a core material mixture which can suitably prevent strength from being abruptly decreased and improve a de-coring property. In certain preferred embodiments, the present invention relates to a method of fabricating a core for a casting and a core for the casting fabricated by the same.

2. Background Art

In general, when a casting having a cavity, such as a circular tube, is fabricated by casting working, a mold having a shape corresponding to the cavity is typically referred to as a core. In an exemplary process of casting a hollow casting, after the core is suitably disposed in the mold, a molten metal is poured into the mold. After the casting is solidified, the casting and core are removed from the mold, and then the core is removed from the casting.

According to methods of fabricating the core, molding sand and a forming binder are suitably mixed, and the forming binder is cured and shaped in a desired shape. Preferably, the molding sand is general sand, and the forming binder preferably includes any one of an inorganic binder and an organic binder. Organic binders are widely used because of fast curing speed. However, when organic binders are used, harmful gas and a condensate are produced that have negative effects on the casting surroundings and the lifespan of the casting mold.

Consequently, studies of using the inorganic binders have been carried out, and in particular studies using a sodium silicate-based binder. The sodium silicate-based binder is known in the prior art to be weak in flexural strength relative to an organic binder, and because of inherent hydroscopic properties of the sodium silicate, binding force is suddenly weakened with a lapse of leaving time under atmosphere, so that its strength is considerably decreased.

Further, sodium silicate-based binders are vitrified at high temperatures of about 540 degrees or more, and the molding is adhered to a surface of the casting when the sand is removed after casting, and thus it is considerably difficult to perform post-treatment.

Accordingly, there is a need in the art for improved core mixture materials.

The above information disclosed in this the Background section is only for enhancement of understanding of the background of the invention and therefore it may contain information that does not form the prior art that is already known in this country to a person of ordinary skill in the art.

### SUMMARY OF THE INVENTION

In one aspect, the present invention provides a core material mixture for casting which can suitably prevent strength from being considerably decreased, a method of fabricating the core for casting, and the core fabricated by the same.

In preferred embodiments, the present invention also provides a core material mixture for casting which can suitably enhance a de-coring property by considerably reducing flexural strength when exposed to high temperatures, a method of fabricating the core for casting, and a core fabricated by the same.

In other preferred embodiments, the present invention provides a core material mixture for casting, including molding sand, and a core binder mixed with the molding sand and made of sodium silicate-based binder and an oxide film inhibitor.

According to further preferred embodiments of the present invention, there is provided a core material mixture for casting, including molding sand, and a sodium silicate-based binder and an additive for decoring.

The present invention also provides a method of fabricating a casting core including molding sand, a core binder consisting of sodium silicate-based binder and an oxide film inhibitor, an additive for de-coring consisting of colloidal silica having particles of 1 to 100 nm, and silica powder having particles of 1 to 20 μm to form a mixture; supplying the mixture to a core mold; and shaping the core by heating the core mold to hydrate the core binder.

According to other preferred embodiments of the present invention, there is provided a core fabricated by the above-described method.

According to preferred embodiments of the present invention as described herein, when the core fabricated by any of the above processes is left under the atmosphere for a long time, it is possible to suitably prevent the flexural strength from being dramatically decreased.

In further preferred embodiments, after exposure to suitably high temperature, the flexural strength is considerably decreased, so that the de-coring property can be suitably enhanced.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum).

As referred to herein, a hybrid vehicle is a vehicle that has two or more sources of power, for example both gasoline-powered and electric-powered.

The above features and advantages of the present invention will be apparent from or are set forth in more detail in the accompanying drawings, which are incorporated in and form a part of this specification, and the following Detailed Description, which together serve to explain by way of example the principles of the present invention.

### BRIEF DESCRIPTION OF THE DRAWINGS

The above and other features of the present invention will now be described in detail with reference to certain exemplary embodiments thereof illustrated by the accompanying drawings which are given hereinafter by way of illustration only, and thus are not limitative of the present invention, and wherein:

FIG. 1 is a graph illustrating the relation of flexural strength to leaving time under atmosphere between a conventional core fabricated using a core material mixture for casting, in which the material is not added with an oxide film inhibitor, and a core of the present invention fabricated by using a core material mixture for casting, in which the material is added with an oxide film inhibitor;

FIG. 2 is a graph illustrating the relation of flexural strength to a conventional inorganic sodium silicate-based binder and organic binder, and a binder for a core according to the present invention; and

FIG. 3 is a graph illustrating the relation of flexural strength to leaving time under atmosphere between a core fabricated by using a core material mixture for casting, in which the material is not added with sorbitol, and a core fabricated by using a core material mixture for casting, in which the material is added with sorbitol.

### DETAILED DESCRIPTION

As described herein, the present invention features a core material mixture for casting, comprising molding sand, and a core binder mixed with the molding sand.

In one embodiment, the core binder is made of sodium silicate-based binder and an oxide film inhibitor.

In another aspect, the present invention features a method of fabricating a casting core comprising the steps of binding molding sand, a core binder consisting of sodium silicate-based binder and an oxide film inhibitor, a additive for de-coring consisting of colloidal silica having particles of between 1 to 100 nm, and silica powder having particles of between 1 to 20 μm to form a mixture, supplying the mixture to a core mold, and shaping the core by heating the core mold to hydrate the core binder.

In one embodiment, the oxide film inhibitor includes at least one of polyethylene glycol, balsam resin, zinc oleate and aluminum stearate, and the oxide film inhibitor is between 0.1 to 0.5 wt %.

In another embodiment, the core binder includes at least one selected from the group consisting of sorbitol, monosaccharide such as sugar, and polysaccharide.

The invention also features a core fabricated by the methods described herein.

The present invention will now be described in detail with reference to the accompanying drawings.

In certain preferred aspects, a core material mixture for a casting according to the present invention preferably includes molding sand, a core binder consisting of sodium silicate-based binder and an oxide film inhibitor, and an additive for suitably enhancing a de-coring property.

Preferably, the molding sand is sand, and preferably has a grain size of 30 to 50 AFS GFN (America Foundry Society Grain Fineness Number).

According to certain preferred embodiments of the present invention, the core binder is a substance of binding materials having suitable viscosity, and preferably consists of a sodium silicon-based binder and an oxide film inhibitor. In further preferred embodiments, the core binder may include at least one of sorbitol, monosaccharide such as sugar, and polysaccharide.

In certain exemplary embodiments, a preferred composition ratio of the core binder to the molding sand is 1 to 5 wt %

In other certain exemplary embodiments, the sodium silicate-based binder preferably consists of Na₂O of 8 to 15 wt % and SiO₂ of 27 to 34 wt %, and preferably, SiO₂: Na₂O=2.4 to 3.5. Preferably, according to the above-mentioned embodiments, the optimum flexural strength is expressed.

According to further preferred embodiments of the present invention, the oxide film inhibitor suitably prevents a binding force from being lost due to the inherent hydroscopic property of the sodium silicate-based binder, and suitably extends a usable time of the sodium silicate-based binder to suitably prevent the flexural strength from being dramatically decreased.

In certain preferred embodiments, the oxide film inhibitor preferably includes at least one of polyethylene glycol, balsam resin, zinc oleate and aluminum stearate. According to further exemplary embodiments, preferably, a composition ratio of the oxide film inhibitor is 0.1 to 0.5 wt %. In certain exemplary embodiments, if the composition ratio deviates from this range, the flexural strength is considerably decreased.

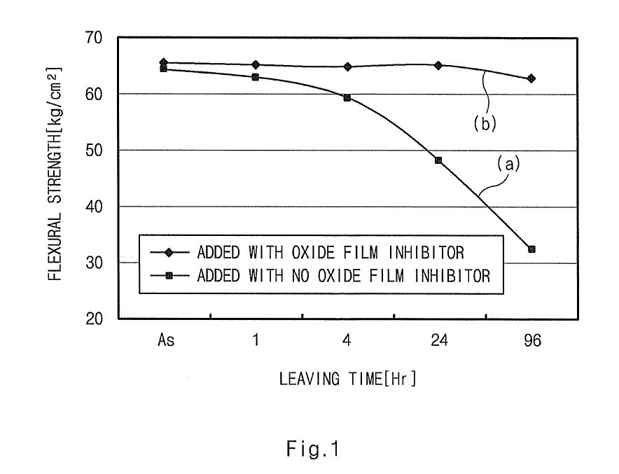

According to exemplary embodiments of the present invention, comparing the effect of the oxide film inhibitor in FIG. 1, in the case of a conventional core fabricated by using a core material mixture for casting, in which the material is not added with an oxide film inhibitor, the flexural strength is considerably decreased (line a) with lapse of leaving time under atmosphere. In other exemplary embodiments, for example in the case of a core suitably fabricated by using a core material mixture for casting, in which the material is added with an oxide film inhibitor, the flexural strength of 60 kg/cm² or more is maintained (line b) even though 96 hours has lapsed.

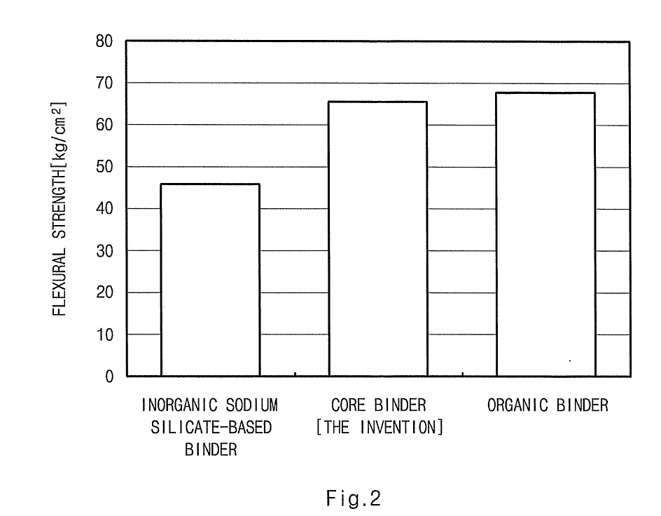

According to preferred embodiments, the flexural strength of the core fabricated by using a core material mixture for casting according to the invention is preferably 60 kg/cm² or more as shown, for example, in FIG. 2, which is remarkably higher than that of the core fabricated by using the conventional sodium silicate-based binder and is similar to that of the core fabricated by using the organic binder. Accordingly, in preferred embodiments of the present invention as described herein, a suitably high flexural strength can be obtained, and further, a suitably high flexural strength can be obtained when an organic binder is not used.

In further preferred embodiments, it is preferable that the core binder further includes at least one of sorbitol, monosaccharide such as sugar, and polysaccharide. If the core binder is exposed to high temperature of 700 degrees or more, the binding force is collapsed and as a result the flexural strength is considerably decreased, so that the binder is easily broken down, which is advantageous for the sand removing property.

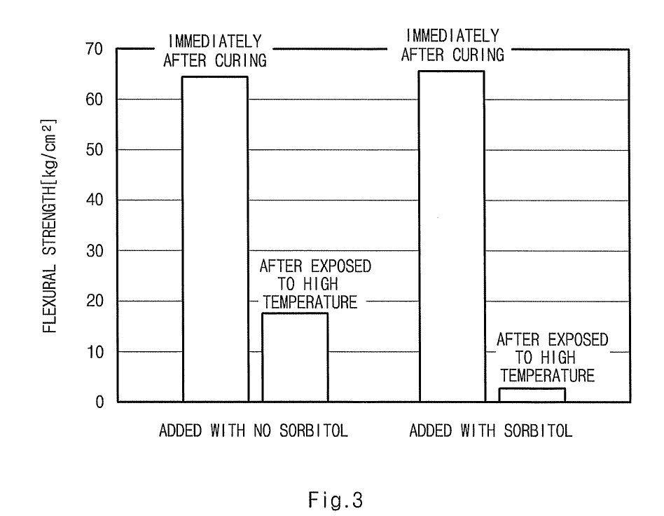

In one exemplary embodiment that compares the effect of the addition of sorbitol, for example as shown in FIG. 3, in the case of the core fabricated by using a core material mixture for casting, in which sorbitol is not added to the material, but the oxide film inhibitor is added to the material, the flexural strength of the core fabricated is suitably maintained at 15 kg/cm² or more, after it is exposed to high temperature. By contrast, in the case of the core fabricated by using a core material mixture for casting, in which sorbitol and the oxide film inhibitor are added to the material, the flexural strength of the core fabricated is considerably decreased by 5 kg/cm² or less, after it is exposed to high temperature.

In further preferred embodiments, it is preferable that an additive for removing sand is added to the core material mixture so as to suitably enhance the sand removing property.

Preferably, the additive for removing sand consists of colloidal silica, silica powder, and moisture, in which a composition ratio of the colloidal silica and silica powder is between 40 to 60%, and the remainder is moisture.

Preferably, the colloidal silica and silica powder are an amorphous spherical particle, and are in the rage of pH 7 to pH 13.

In further preferred embodiments, the particle of the colloidal silica is between 1 to 100 nm, and the particle of the silica powder is between 1 to 20 μm. A volume ratio of colloidal silica to silica powder is preferably between 0.8 to 1.2.

The present invention also features a method of fabricating the core. A method of fabricating the core by using the core material mixture for the casting according to certain exemplary embodiments is described herein.

In a first embodiment, the molding sand, the core binder, and the additive for de-coring are preferably added and mixed in a kneader. Preferably, the core binder consists of a sodium silicon-based binder and an oxide film inhibitor, and the oxide film inhibitor suitably prevents the flexural strength from being decreased due to the hydroscopic property of the sodium silicate. Preferably, by the addition of the additive for de-coring, the core can be easily removed from the casting.

In further exemplary embodiments, after the mixture blended in the process is suitably supplied to a core mold, the core mold is suitably heated to dehydrate the core binder, thereby completing the shaping of the core.

Accordingly, even though the core fabricated by the above process is left under the atmosphere for a long time, it is possible to suitably prevent the flexural strength from being considerably decreased, and after exposure to high temperature, the flexural strength is considerably decreased, so that the sand removing property can be enhanced.

Although a preferred embodiment of the present invention has been described for illustrative purposes, those skilled in the art will appreciate that various modifications, additions and substitutions are possible, without departing from the scope and spirit of the invention as disclosed in the accompanying claims.

What is claimed is:

1. A core material mixture for casting, comprising:
molding sand; and
a core binder mixed with the molding sand and made of sodium silicate-based binder and an oxide film inhibitor.

2. The core material mixture according to claim 1, wherein the oxide film inhibitor includes at least one selected from the group consisting of: polyethylene glycol, balsam resin, zinc oleate and aluminum stearate.

3. The core material mixture according to claim 2, wherein the oxide film inhibitor is between 0.1 to 0.5 wt %.

4. The core material mixture according to claim 1, further comprising an additive for de-coring to enhance a sand removing property.

5. The core material mixture according to claim 4, wherein the additive for de-coring consists of colloidal silica, silica powder, and moisture.

6. The core material mixture according to claim 5, wherein a composition ratio of the colloidal silica and silica powder is between 40 to 60%.

7. The core material mixture according to claim 5, wherein the particle of the colloidal silica is between 1 to 100 nm, and the particle of the silica powder is between 1 to 20 μm.

8. The core material mixture according to claim 7, wherein a volume ratio of colloidal silica to silica powder is between 0.8 to 1.2.

9. The core material mixture according to claim 1, wherein the core binder includes at least one selected from the group consisting of: sorbitol, monosaccharide such as sugar, and polysaccharide.

10. The core material mixture according to claim 1, wherein a composition ratio of the core binder to the molding sand is between 1 to 5 wt %.

11. The core material mixture according to claim 10, wherein the sodium silicate-based binder consists of Na₂O of between 8 to 15 wt % and SiO₂ of between 27 to 34 wt %, in which SiO₂:Na₂O=2.4 to 3.5.

12. A core material mixture for casting, comprising:
molding sand; and
a sodium silicate-based binder and an additive for de-coring mixed with the molding sand.

13. The core material mixture according to claim 12, wherein the additive for de-coring consists of colloidal silica, silica powder, and moisture, and a composition ratio of the colloidal silica and silica powder is between 40 to 60%.

14. The core material mixture according to claim 13, further comprising a core binder including at least one selected from the group consisting of: sorbitol, monosaccharide such as sugar, and polysaccharide.
